(19) United States
(12) Patent Application Publication
(10) Pub. No.: US 2026/0035100 A1
(43) Pub. Date: Feb. 5, 2026

(54) VEHICLE FOR TOWING AIRCRAFT

(71) Applicant: Oshkosh Corporation, Oshkosh, WI (US)

(72) Inventor: William Lunt, Oshkosh, WI (US)

(73) Assignee: Oshkosh Corporation, Oshkosh, WI (US)

(21) Appl. No.: 19/286,799

(22) Filed: Jul. 31, 2025

Related U.S. Application Data
(60) Provisional application No. 63/678,129, filed on Aug. 1, 2024.
(60) Provisional application No. 63/678,122, filed on Aug. 1, 2024.
(60) Provisional application No. 63/678,126, filed on Aug. 1, 2024.
(60) Provisional application No. 63/678,131, filed on Aug. 1, 2024.

(51) Int. Cl. B64F 1/227; B66D 1/48

(52) U.S. Cl. CPC B64F 1/227; B66D 1/485

(57) ABSTRACT

A towbarless tractor system includes one or more processing circuits configured to monitor a capture system of a towbarless tractor based on visual data acquired by a sensor on the towbarless tractor, the capture system configured to engage with a nose gear, and store or transmit at least a portion of the visual data acquired by the sensor of the towbarless tractor regarding the capture system in response to an event.

### CROSS-REFERENCE TO RELATED PATENT APPLICATIONS

This application claims the benefit of and priority to U.S. Provisional Patent Application No. 63/678,122, filed Aug. 1, 2024, U.S. Provisional Patent Application No. 63/678,126, filed Aug. 1, 2024, U.S. Provisional Patent Application No. 63/678,129, filed Aug. 1, 2024, and U.S. Provisional Patent Application No. 63/678,131, filed Aug. 1, 2024, all of which are incorporated herein by reference in their entireties.

### BACKGROUND

Airplanes are typically towed by a tractor at an airport to reposition the airplane during departure or arrival from a gate, transport the airplane to or from a hangar, or to otherwise move the airplane. During capture operations performed by the tractor, a nose gear of the airplane may be damaged due to improper procedures, malfunctioning equipment, or any other reason. Determining a cause of the damage may be difficult without image data (e.g., photos and videos) of the nose gear and the tractor.

### SUMMARY

One embodiment relates to a towbarless tractor system. The towbarless tractor system includes one or more processing circuits configured to monitor a capture system of a towbarless tractor based on visual data acquired by a sensor on the towbarless tractor, the capture system configured to engage with a nose gear, and store or transmit at least a portion of the visual data acquired by the sensor of the towbarless tractor regarding the capture system in response to an event.

Another embodiment relates to a towbarless tractor for towing an airplane having a nose gear. The towbarless tractor includes a chassis, a plurality of tractive assemblies coupled to the chassis, a capture system including a cradle configured to support the nose gear and a winch assembly including a winch strap configured to selectively couple with the nose gear, the winch assembly configured to selectively retract such that the cradle supports the nose gear, one or more sensors configured to capture visual data regarding the capture system and the nose gear, and a control system configured to control the winch assembly to pay out the winch strap, control the winch assembly to retract the winch strap when the winch strap is coupled with the nose gear, thereby causing the nose gear to be supported by the cradle, and store or transmit at least a portion of the visual data captured by the one or more sensors in response to an event.

Still another embodiment relates to a towbarless tractor system. The towbarless tractor system includes one or more processing circuits configured to control a capture system of a towbarless tractor to pay out a winch strap, the winch strap configured to engage with a nose gear of an airplane, control the capture system to retract the winch strap when the winch strap is coupled with the nose gear to pull the towbarless tractor towards the airplane such that a cradle of the capture system is pulled underneath the nose gear, monitor the capture system based on visual data acquired by one or more sensors on the towbarless tractor, and store or transmit at least a portion of the visual data in response to an event. The event includes at least one of the towbarless tractor crashing, the airplane crashing, an improper alignment of the nose gear with the capture system, full engagement of the capture system with the nose gear, or the airplane inadvertently disengaging from the capture system.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a tractor towing an airplane, according to an exemplary embodiment.

FIG. 2 is a front, left perspective view of the tractor of FIG. 1, according to an exemplary embodiment.

FIG. 3 is a detailed rear, left perspective view of a seating area of the tractor of FIG. 2, according to an exemplary embodiment.

FIG. 4 is a detailed view of the seating area of FIG. 3, according to an exemplary embodiment.

FIG. 5 is a detailed view of a capture system of the tractor of FIG. 2, according to an exemplary embodiment.

FIG. 6 is a perspective view of the airplane supported by and coupled with the tractor of FIG. 1 using the capture system of FIG. 5, according to an exemplary embodiment.

FIG. 7 is a schematic block diagram of the tractor of FIG. 1, according to an exemplary embodiment.

FIG. 8 a flow chart of a method for capturing the airplane of FIG. 1 using the tractor of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

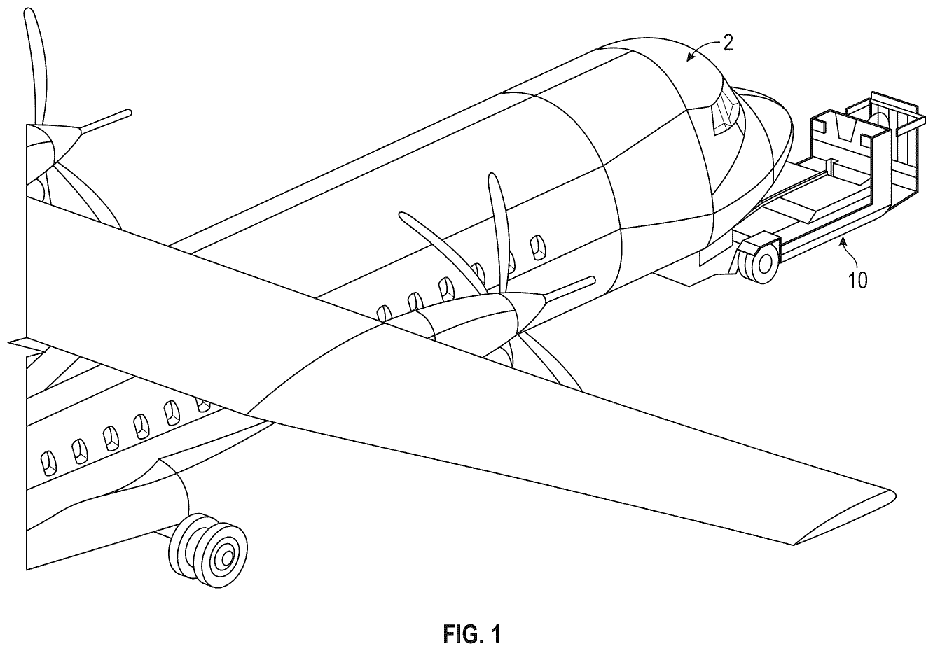

As shown in FIGS. 1-7, a tow vehicle (e.g., an aircraft tow vehicle, a tow-bar-less tow vehicle, an aircraft tractor, etc.), shown as tractor 10, is configured to couple with and support at least a portion (e.g., a nose gear, a landing gear, a nose landing gear, etc.) of an aircraft, show as airplane 2, to tow, pushback, or otherwise manipulate the airplane 2. According to an exemplary embodiment, the tractor 10 is used for one or more operations at an airport including pushing the airplane 2 during pushback operations (e.g., departing from a gate), towing the airplane 2 between locations (e.g., between gates, hangars, fueling areas, maintenance areas, de-icing areas, etc.), positioning the airplane 2 (e.g., into proper alignment at a gate with a bridge), and/or other operations.

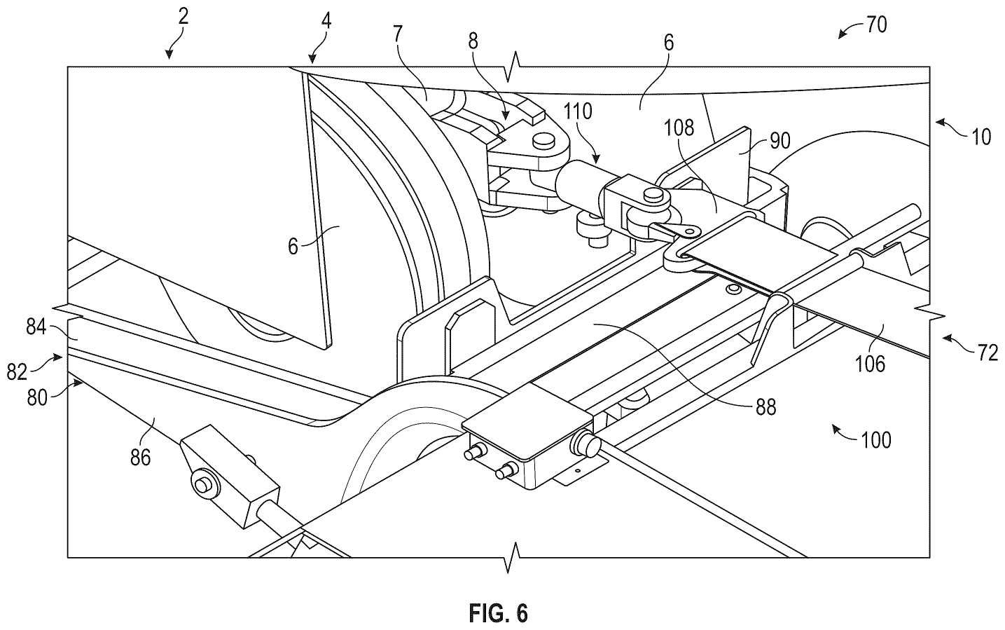

As shown in FIG. 6, the airplane 2 includes a nose gear assembly, shown as nose gear 4. The nose gear 4 includes two tractive elements, shown as wheels 6, and a shaft member (e.g., a strut, post, rod, etc.), shown as pivot 7, coupled between the wheels 6 and a fuselage of the airplane 2. The wheels 6 are rotatably coupled with the pivot 7 and are configured to engage a ground surface (e.g., tarmac, road, etc.). The nose gear 4 is steerable to facilitate steering the airplane 2. In some embodiments, the nose gear 4 includes more or fewer than two wheels 6. As shown in FIG. 6, the nose gear 4 includes a securing element (e.g., a mechanical linkage, a towing adapter, a tow ball, a hook, a tow eye, etc.), shown as tow element 8, coupled with the pivot 7, and configured to facilitate a coupling between the nose gear 4 and the tractor 10 (e.g., the winch-capture system 72). In some embodiments, the nose gear 4 does not include the tow element 8 and coupling between the nose gear 4 and the tractor 10 is accomplished in another manner (e.g., by a coupling between the wheels 6 and the winch-capture system 72 and/or the hands-free capture system 200, directly between the pivot 7 and the tractor 10 by securing a strap around the pivot 7, etc.).

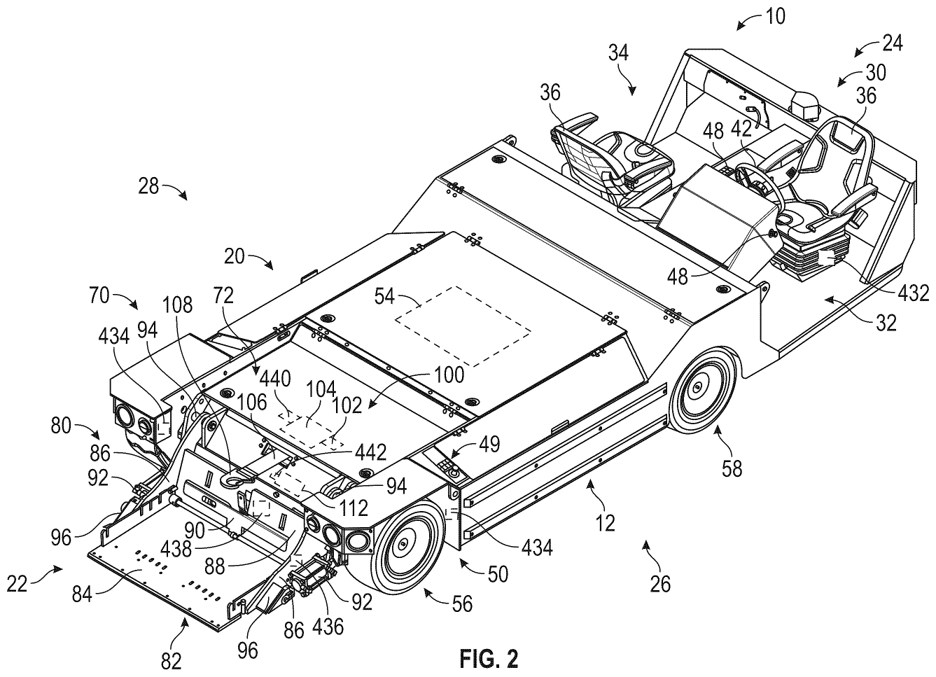

As shown in FIGS. 2-7, the tractor 10 includes a chassis, shown as frame 12; a body assembly, shown as body 20, coupled to the frame 12 and having an occupant portion or section, shown as occupant seating area 30; first operator input and output devices, shown as first operator controls 40, that are disposed within the occupant seating area 30; second operator input and output devices, shown as second operator controls 49, that are disposed outside of the occupant seating area 30; a drivetrain, shown as driveline 50, coupled to and/or supported by the frame 12; a braking assembly, shown as braking system 60, coupled to one or more components of the driveline 50 to facilitate selectively braking the one or more components of the driveline 50; an aircraft capture system, shown as capture system 70, coupled to the frame 12 and/or the body 20; and a control system, shown as tractor control system 400, coupled to the first operator controls 40, the driveline 50, the braking system 60, the capture system 70, and the second operator controls 49. In some embodiments, the tractor 10 includes more or fewer components.

As shown in FIGS. 2, 3, and 5, the tractor 10 has a first end, shown as front end 22, a second end, shown as rear end 24, opposite the front end 22, a first side, shown as left side 26, and a second side, shown as right side 28, opposite the left side 26. According to the exemplary embodiment shown in FIGS. 2-4, the occupant seating area 30 includes a plurality of operator compartments including a first operator compartment, shown as forward travel compartment 32, and a second operator compartment, shown as rearward travel compartment 34. In some embodiments, the occupant seating area 30 includes a third operator compartment positioned forward, rearward, or between the forward travel compartment 32 and the rearward travel compartment 34. In some embodiments, the occupant seating area 30 does not include the rearward travel compartment 34.

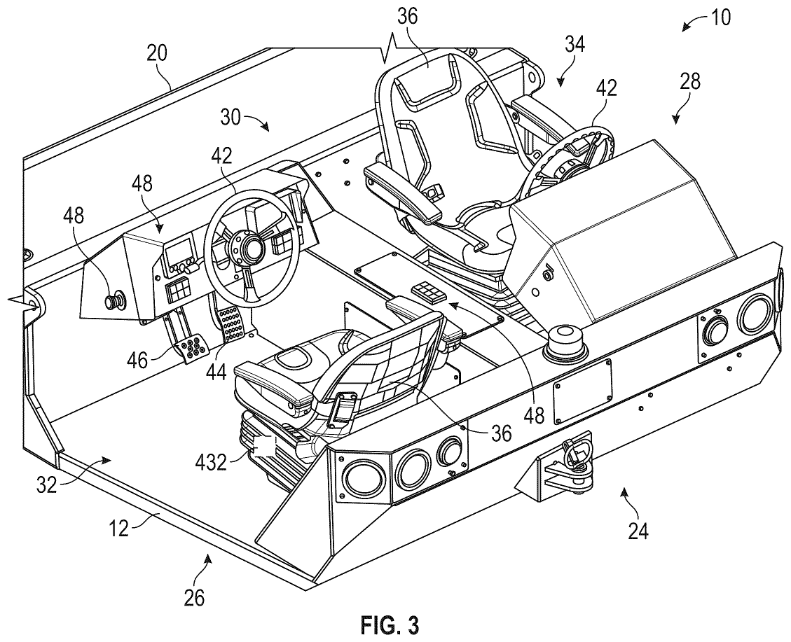

As shown in FIGS. 2-4, each of the forward travel compartment 32 and the rearward travel compartment 34 include an operator seat, shown as seat 36. As shown in FIGS. 2 and 3, the seat 36 of the forward travel compartment 32 is oriented facing the front end 22 such that an operator can control operation of the tractor 10 while facing the front end 22. The seat 36 of the rearward travel compartment 34 is oriented facing the rear end 24 such that an operator can control operation of the tractor 10 while facing the rear end 24. In other embodiments, the forward travel compartment 32 and the rearward travel compartment 34 face the same direction (e.g., in a direction towards the front end 22 or the rear end 24). In some embodiments, the seat 36 of the forward travel compartment 32 and the seat of the rearward travel compartment 34 are movable (e.g., rotatable, repositionable, etc.) to change a direction in which the seats 36 are facing (e.g., depending on a direction of travel of the tractor 10). As shown in FIGS. 2 and 3, the forward travel compartment 32 is positioned along the left side 26 of the tractor 10 and the rearward travel compartment 34 is positioned along the right side 28 of the tractor 10. In other embodiments, the forward travel compartment 32 is positioned along the right side 28 of the tractor 10 and the rearward travel compartment 34 is positioned along the left side 26 of the tractor 10.

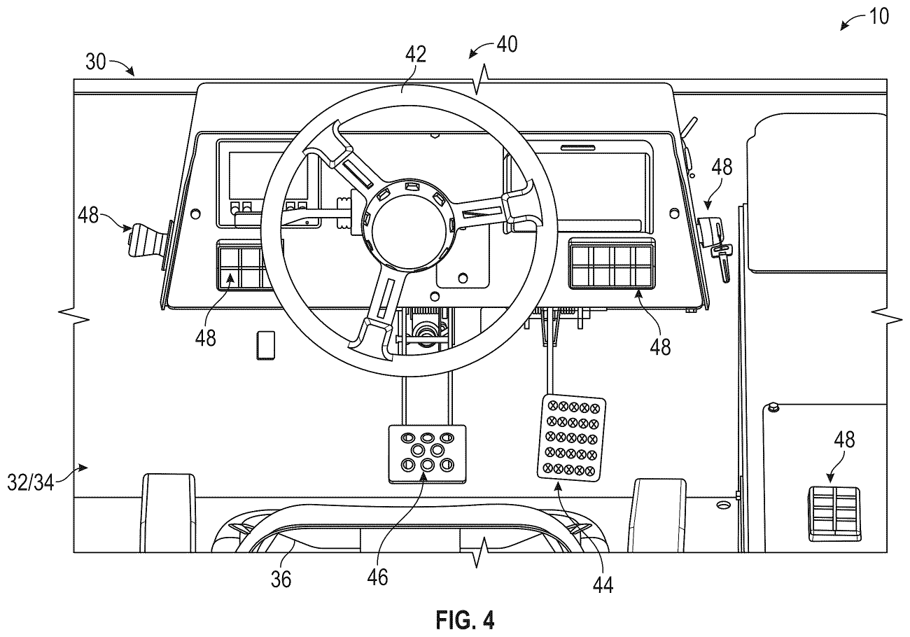

According to an exemplary embodiment, the first operator controls 40 are configured to provide an operator with the ability to control one or more functions of and/or provide commands to the tractor 10 and the components thereof (e.g., turn on, turn off, drive, turn, brake, engage various operating modes, raise/lower the cradle 82 of the cradle assembly 80, payout or take-up the winch strap 106 of the winch-capture system 72, etc.). As shown in FIGS. 3 and 4, the first operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a liquid crystal display (“LCD”), a light emitting diode (“LED”) display, a speedometer, gauges, warning lights, etc. The one or more displays are configured to display information and/or warnings relating to the operation of the tractor 10. The one or more input devices may be or include buttons, switches, knobs, levers, dials, etc.

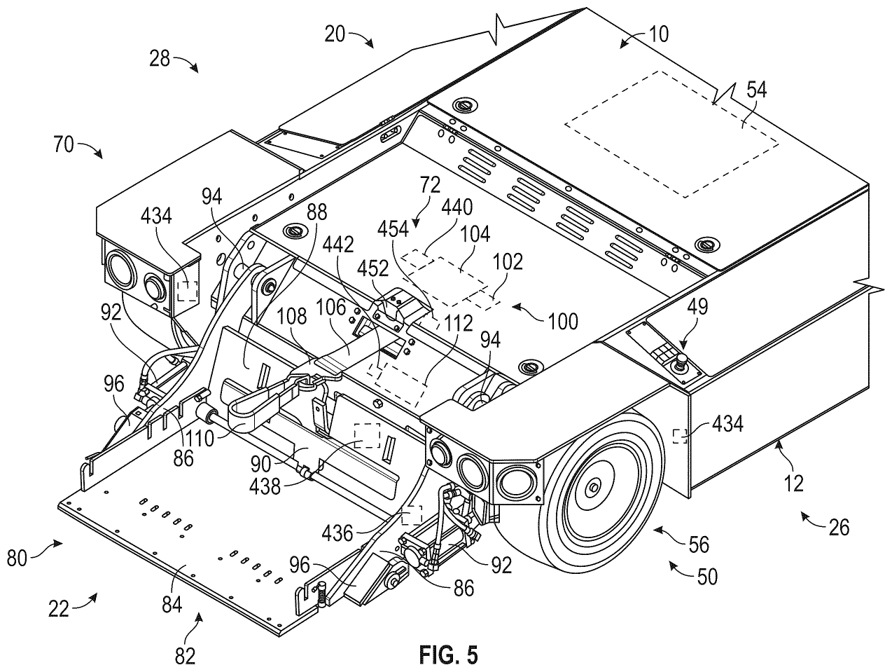

As shown in FIGS. 4 and 5, each of the forward travel compartment 32 and the rearward travel compartment 34 include the first operator controls 40. The first operator controls 40 of the forward travel compartment 32 may be used to control operation of the tractor 10 (e.g., driving, steering, and braking operations, cradle operations, winching operations, etc.) when the tractor 10 is in a first mode of operation (e.g., a forward travel mode, an approach mode, a capture mode, a pushback mode, etc.) and the first operator controls 40 of the rearward travel compartment 34 may be used to control operation of the tractor 10 when the tractor 10 is in a second mode of operation (e.g., a rearward travel mode, a tow mode, a return mode, etc.). In some embodiments, one of the forward travel compartment 32 or the rearward travel compartment 34 does not include the first operator controls 40. In such embodiments, the seats 36 may face the same direction or be replaced with a single, bench-style seat. An operator may provide an input to the first operator controls 40 (e.g., to the operator interface 48) to switch between the first mode of operation in which operation of the tractor 10 is controlled by the forward travel compartment 32 and the second mode of operation in which operation of the tractor 10 is controlled by the rearward travel compartment 34.

According to an exemplary embodiment, the second operator controls 49 are configured to provide an operator with the ability to control one or more functions of and/or provide commands to the tractor 10 and the components thereof (e.g., turn on, turn off, engage various operating modes, raise/lower the cradle 82 of the cradle assembly 80, payout or take-up the winch strap 106 of the winch-capture system 72, operate the hands-free capture system 200, etc.). The second operator controls 49 may include one or more displays and one or more input devices. The one or more displays may be or include a touchscreen, a LCD display, a LED display, a speedometer, gauges, warning lights, etc. The one or more displays are configured to display information and/or warnings relating to the operation of the tractor 10. The one or more input devices may be or include buttons, switches, knobs, levers, dials, etc. As shown in FIGS. 2 and 5, the second operator controls 49 are positioned along an exterior of the body 20 proximate the front end 22 of the tractor 10. The second operator controls 49 are positioned outside of the forward travel compartment 32 and the rearward travel compartment 34, and are separate from the operator interface 48 of the first operator controls 40 such that an operator can control operation of the tractor 10 while positioned outside of the forward travel compartment 32 and the rearward travel compartment 34. The position of the second operator controls 49 makes it easier for the operator to control the capture system 70 because the operator is positioned closer thereto (and therefore, less obstructions are positioned between the operator and the winch-capture system 72 and/or the hands-free capture system 200). In some embodiments, each of the second operator controls 49 and the operator interface 48 control the same components of the tractor 10 (e.g., operation of the braking system 60). Additionally or alternatively, in some embodiments, the second operator controls 49 control a first subset of components of the tractor 10 (e.g., operation of the capture system 70) and the operator interface 48 controls a second subset of components of the tractor 10 (e.g., operation of the driveline 50).

According to an exemplary embodiment, the driveline 50 is configured to propel the tractor 10. As shown in FIGS. 2, 5, and 7, the driveline 50 includes a primary driver, shown as prime mover 52, an energy storage device, shown as energy storage 54, a first tractive assembly (e.g., axles, wheels, tracks, differentials, etc.), shown as front tractive assembly 56, and a second tractive assembly (e.g., axles, wheels, tracks, differentials, etc.), shown as rear tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIGS. 2 and 5, the front tractive assembly 56 includes front tractive elements and the rear tractive assembly 58 includes rear tractive elements that are configured as wheels. In some embodiments, the front tractive elements and/or the rear tractive elements are configured as tracks.

According to an exemplary embodiment, the prime mover 52 is configured to provide power to drive the front tractive assembly 56 and/or the rear tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the front tractive assembly 56 and/or the rear tractive assembly 58. The front tractive assembly 56 and/or the rear tractive assembly 58 may include a drive shaft, a differential, and/or an axle. In some embodiments, the front tractive assembly 56 and/or the rear tractive assembly 58 include two axles or a tandem axle arrangement. In some embodiments, the front tractive assembly 56 and/or the rear tractive assembly 58 are steerable (e.g., using the steering wheel 42). In some embodiments, both the front tractive assembly 56 and the rear tractive assembly 58 are fixed and not steerable (e.g., employ skid steer operations).

In some embodiments, the driveline 50 includes a plurality of prime movers 52. By way of example, the driveline 50 may include a first prime mover 52 that drives the front tractive assembly 56 and a second prime mover 52 that drives the rear tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 56, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 58, a second prime mover 52 that drives a first one of the front tractive elements, and a third prime mover 52 that drives a second one of the front tractive elements.

In some embodiments, the tractor 10 includes a suspension system including one or more suspension components (e.g., shocks, dampers, springs, etc.) positioned between the frame 12 and one or more components (e.g., tractive elements, axles, etc.) of the front tractive assembly 56 and/or the rear tractive assembly 58. In some embodiments, the tractor 10 does not include the suspension system.

According to an exemplary embodiment, the braking system 60 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 56 (e.g., the front axle, the front tractive elements, etc.) and (ii) one or more rear braking components positioned to facilitate braking one or more components of the rear tractive assembly 58 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the braking system 60 is configured to facilitate braking one or more components of the driveline 50 responsive to an input received from the first operator controls 40. By way of example, responsive to interfacing with (e.g., engaging, depressing, pushing, etc.) the brake 46, the braking system 60 may be configured to facilitate braking one or more components of the driveline 50. By way of another example, responsive to interfacing with (e.g., engaging, pressing, turning, pulling, etc.) one or more input devices of the operator interface 48, the braking system 60 may be configured to engage a parking brake to brake the front tractive elements and/or the rear tractive elements. In such an example, responsive to engaging the parking brake, the one or more displays of the operator interface 48 may provide an indication (e.g., flash a light, play a sound, display a message, play a message, etc.) that the parking brake is engaged. In some embodiments, electric regenerative braking is employed (e.g., via the prime mover 52, an electric motor, etc.) in combination with or instead of using the braking system 60 to facilitate braking of one or more components of the driveline 50. By way of example, the prime mover 52 may be back-driven by the front axle of the front tractive assembly 56 and/or the rear axle of the rear tractive assembly 58 though an axle interface during a braking event.

### Capture System

According to the exemplary embodiment shown in FIGS. 1, 2, 5, and 6, the tractor 10 is configured as a towbarless tractor that couples with the airplane 2 using a “soft-capture” or “winch-capture” system/mechanism. In other embodiments, the tractor 10 is configured as another type of tractor that couples with the airplane 2 using a “hard-capture” or “hands-free” capture system/mechanism. As shown in FIGS. 2, 5, 6, and 7, the capture system 70 includes either (i) a “winch-capture” system/mechanism, shown as winch-capture system 72, or (ii) a “hard-capture” system/mechanism, shown as hands-free capture system 200. According to the exemplary embodiment shown in FIGS. 2, 5, and 6, the tractor 10 is configured as a towbarless tractor that couples with the airplane 2 using the winch-capture system 72.

### Winch-Capture System

As shown FIGS. 2, 5, 6, and 7, the winch-capture system 72 includes a first aircraft support assembly (e.g., bucket assembly, ramp assembly, etc.), shown as cradle assembly 80, and a towing mechanism, shown as winch assembly 100. According to an exemplary embodiment, the winch assembly 100 is configured to engage with the nose gear 4 of the airplane 2 to pull the cradle assembly 80 under the nose gear 4 (or pull the airplane 2 on top of the cradle assembly 80) and the cradle assembly 80 is configured to support the nose gear 4 of the airplane 2 and lift the front end of the airplane 2 to facilitate towing, pushing, or otherwise repositioning the airplane 2 with the tractor 10. By way of example, the cradle assembly 80 is configured to space or lift the nose gear 4 of the airplane 2 from a ground surface and carry the nose gear 4 as the tractor 10 is driven to reposition the airplane 2. As shown in FIGS. 2, 5, and 6, the cradle assembly 80 and the winch assembly 100 are positioned at or proximate the front end 22 of the tractor 10. In some embodiments, the cradle assembly 80 and/or the winch assembly 100 are otherwise positioned about the tractor 10 (e.g., at or proximate the rear end 24).

As shown in FIGS. 2, 5, and 6, the cradle assembly 80 includes an aircraft support (e.g., a bucket, a ramp, etc.), shown as cradle 82, having a support deck, shown as bottom plate 84, side supports (e.g., side gates), shown as sidewalls 86, and a rear support (e.g., rear gate), shown as back wall 88. Collectively, the bottom plate 84, the sidewalls 86, and the back wall 88 define an area configured to load/unload the nose gear 4 of the airplane 2 onto/from the cradle 82, space the nose gear 4 from the ground surface, and support the nose gear 4 during transportation of the tractor 10 and the airplane 2 being towed or pushed thereby.

As shown in FIGS. 2, 5, and 6, the bottom plate 84 extends within a substantially horizontal plane (e.g., when the cradle 82 is positioned to receive or unload the airplane 2 therefrom). The bottom plate 84 is configured to support the wheels 6 of the nose gear 4 of the airplane 2 during towing and pushback operations of the tractor 10. The bottom plate 84 provides a surface (e.g., a ramp) for the wheels 6 of the nose gear 4 to contact during winching operations to facilitate loading the nose gear 4 of the airplane 2 onto and unloading the nose gear 4 of the airplane 2 from the cradle 82. In some embodiments, the cradle assembly 80 includes a wear plate positioned between the bottom plate 84 and the ground surface. The wear plate may be configured to contact the ground surface (e.g., instead of the bottom plate 84 contacting the ground surface) to prevent wear on the bottom plate 84. The wear plate may be selectively coupled to the bottom plate 84 or another component of the cradle 82 to facilitate replacing the wear plate after repeated use thereof (e.g., the wear plate may wear away or be damaged due to repeated contact with the ground surface). The wear plate may be manufactured from steel (e.g., abrasion resistant steel, hardened steel, carbon steel, stainless steel, etc.,), a polymer (e.g., ultra-high molecular weight polyethylene, fiberglass-reinforced plastics, etc.), and/or any other material suitable for withstanding abrasions, scrapes, and impacts against the ground surface.

As shown in FIGS. 2, 5, and 6, the sidewalls 86 are coupled to the bottom plate 84 along opposing lateral sides thereof (e.g., the sidewalls 86 are laterally spaced apart from each other by the bottom plate 84) and extend in a substantially vertical direction from the bottom plate 84. The sidewalls 86 may provide support to lateral sides of the nose gear 4 and may provide a barrier (e.g., a stop) to limit rotation of the nose gear 4 (e.g., about the pivot 7) within the cradle 82. By way of example, the sidewalls 86 may be laterally spaced apart (e.g., in a direction between the left side 26 and the right side 28) by a distance at least greater than a lateral width of the nose gear 4 to facilitate loading and unloading the nose gear 4 of the airplane 2 onto and from the cradle 82. In some embodiments, positions of the sidewalls 86 are adjustable to vary the lateral distance therebetween to accommodate for varying sizes of the nose gear 4 of different airplanes 2 (e.g., the lateral distance can be made smaller or larger for an airplane 2 with a smaller or larger nose gear 4). In other embodiments, the cradle 82 includes side plates separate from the sidewalls 86 that are adjustable to vary the lateral distance therebetween to accommodate for variously sized nose gears 4.

As shown in FIGS. 2 and 5, the back wall 88 extends from the bottom plate 84 in a lateral direction between the sidewalls 86. The back wall 88 is configured to provide a barrier (e.g., a stop) to limit longitudinal translation (e.g., in a direction between the front end 22 and the rear end 24) of the nose gear 4 within the cradle 82. By way of example, contact between the nose gear 4 (e.g., the wheels 6 of the nose gear 4) and the back wall 88 limits movement of the nose gear 4 and the airplane 2 in a direction towards the rear end 24. In some embodiments, the cradle 82 includes a front gate pivotably coupled to a front or free edge of the cradle 82 (e.g., a front or free edge of the bottom plate 84) such that (i) when the airplane 2 is supported by the cradle 82, the front gate pivots to a position to limit movement of the nose gear 4 and the airplane 2 off of the cradle 82 (e.g., in a direction away from the front end 22) and (ii) during loading and unloading operations, the front gate pivots to a position to permit movement of the nose gear 4 (e.g., does not block or limit the nose gear 4 of the airplane 2 from being loaded or unloaded from the cradle 82). In some embodiments, the front gate provides a ramped surface to facilitate (i) loading the nose landing gear 4 of the airplane 2 onto the bottom plate 84 from the ground surface and (ii) unloading the nose landing gear 4 of the airplane 2 off of the bottom plate 84 and onto the ground surface.

As shown in FIGS. 2 and 5, the cradle assembly 80 includes a winch shutoff plate, shown as switch plate 90, pivotably coupled to the cradle 82 at or proximate the back wall 88. The switch plate 90 may be coupled with a limit switch (e.g., the sensor 438, a position sensor, a mechanical switch, etc.) configured to detect a position of the switch plate 90. By way of example, when the nose gear 4 comes into contact with the switch plate 90, the switch plate 90 pivots and comes into contact or otherwise engages with the limit switch. In such an example, responsive to engagement of the limit switch, a determination may be made that the nose gear 4 is fully loaded onto the cradle 82 and winching operations may be stopped (e.g., automatically stopped). In some embodiments, the cradle assembly 80 does not include the switch plate 90 and/or the limit switch.

As shown in FIGS. 2 and 5, the cradle assembly 80 includes one or more actuators (e.g., hydraulic cylinders, pneumatic cylinders, electric actuators, motor-driven leadscrews, etc.), shown as lift actuators 92, configured to extend and retract to selectively raise (e.g., and thus raise the nose gear 4 when received by the cradle 82) and lower (e.g., and thus lower the nose gear 4 when received by the cradle 82) the cradle 82. As shown in FIGS. 2 and 5, the cradle 82 is pivotably coupled with the body 20 of the tractor 10 by one or more pivot pins (e.g., a shaft, a fastener, etc.), shown as pins 94. A first one of the pins 94 is configured to extend through an aperture of a first one of the sidewalls 86 and a second one of the pins 94 is configured to extend through an aperture of a second one of the sidewalls 86 to rotatably couple the cradle 82 with the body 20. In some embodiments, a single pin 94 is configured to extend through each of the aperture of the first one of the sidewalls 86 and the aperture of the second one of the sidewalls 86 to rotatably couple the cradle 82 with the body 20. In other embodiments, the cradle 82 is otherwise rotatably coupled with the body 20.

As shown in FIGS. 2 and 5, the lift actuators 92 are coupled between the cradle 82 and the frame 12. Specifically, one end (e.g., an outer end) of the lift actuators 92 is coupled (e.g., pivotably coupled) to exterior facing surfaces of the sidewalls 86 (e.g., surfaces of the sidewalls 86 facing the left side 26 and the right side 28, respectively) by a bracket, shown as actuator bracket 96, and an opposite end (e.g., a base end) of the lift actuators 92 is coupled to the frame 12. In this manner, extension of the lift actuators 92 to an extended position, which corresponds with a first, raised position of the cradle 82, pivots the cradle 82 relative to the frame 12 and the body 20 about the pins 94 and raises the cradle 82 to space the bottom plate 84 from the ground surface. Similarly, retraction of the lift actuators 92 to a retracted position, which corresponds with a second, lowered position of the cradle 82, pivots the cradle 82 relative to the frame 12 and the body 20 about the pins 94 (e.g., from the first, raised position to the second, lowered position) and lowers the cradle 82 such that the bottom plate 84 (e.g., or the wear plate) contacts the ground surface. In some embodiments, gravity and/or a weight of the cradle 82 retracts the lift actuators 92. In some embodiments, the cradle assembly 80 includes more or fewer than two of the lift actuators 92. The tractor 10 may include various components to drive the lift actuators 92 (e.g., pumps, valves, compressors, motors, batteries, voltage regulators, powered by electricity provided by the energy storage 54, etc.).

As shown in FIGS. 2, 5, and 6, the winch assembly 100 includes a drive system (e.g., electric motor, internal combustion engine, a hydraulically-operated motor, etc.), shown as motor 102, a drum (e.g., reel, spool, spindle, etc.), shown as winch drum 104, operatively coupled with the motor 102, a cable (e.g., tow rope, chain, tow strap, etc.), shown as winch strap 106, configured to wind about and unwind from the winch drum 104, a coupler (e.g., engagement feature), shown as winch hook 108, positioned at a free end of the winch strap 106 (e.g., a free end of the winch strap 106 opposite an end coupled to the winch drum 104), an airplane engagement feature (e.g., nose gear coupler, strut strap, linkage, etc.), shown as airplane coupler 110, coupled with the winch hook 108, and a hook and coupler storage compartment (e.g., bin, rack, hook, etc.), shown as storage compartment 112.

The motor 102 is configured to provide rotational energy to the winch drum 104 to rotate the winch drum 104. The winch strap 106 is coupled with the winch drum 104 (e.g., at an end of the winch strap 106 opposite the free end at which the winch hook 108 is positioned) and configured to wind around and unwind from the winch drum 104 as the winch drum 104 is driven by the motor 102. By way of example, responsive to the motor 102 providing rotational energy to rotate the winch drum 104 in a first direction, the winch strap 106 is unwound (e.g., paid out, let out, etc.) from the winch drum 104. By way of another example, responsive to the motor 102 providing rotational energy to rotate the winch drum 104 in a second direction opposite the first direction, the winch strap 106 is wound around (e.g., taken up by) the winch drum 104. In some embodiments, the motor 102 is configured to vary the rate at which the winch strap 106 is wound or unwound from the winch drum 104 by adjusting the rotational energy (e.g., the voltage) supplied to the winch drum 104. In some embodiments, the winch-capture system 72 includes a gear box (e.g., a transmission) configured to facilitate adjusting the output speed and torque for rotating the winch drum 104.

As shown in FIGS. 2 and 5, the motor 102 and the winch drum 104 are positioned within an interior chamber of the body 20. The winch strap 106 is configured to extend outside of the body 20 from the winch drum 104. As shown in FIGS. 2 and 5, the free end of the winch strap 106 to which the winch hook 108 is coupled extends outside of the body 20 through a winch aperture defined thereby. The winch hook 108 is configured as a hook (e.g., a carabiner) defining an interface configured to selectively couple with the airplane coupler 110. As shown in FIG. 5, the airplane coupler 110 is configured as a strut strap where ends thereof are configured to be engaged by the interface of the winch hook 108 such that the ends of the airplane coupler 110 are received within an aperture of the winch hook 108 to couple the airplane coupler 110 with the winch hook 108. One of the ends of the airplane coupler 110 may be released from the aperture (e.g., not coupled with the winch hook 108) to facilitate securing the airplane coupler 110 and the winch-capture system 72 to the airplane 2. By way of example, after decoupling a respective end of the airplane coupler 110 from the winch hook 108, the airplane coupler 110 may be wrapped around the pivot 7 of the airplane 2 and the respective end of the airplane coupler 110 may be coupled with the winch hook 108 to couple the nose gear 4 of the airplane 2 with the winch-capture system 72 (e.g., at which point the nose gear 4 of the airplane 2 can be loaded onto or unloaded from the cradle 82). In some embodiments, the airplane coupler 110 is configured as a bracket assembly or a mechanical linkage to engage with the tow element 8 of the airplane 2 to couple the airplane 2 with the winch-capture system 72. In other embodiments, the airplane coupler 110 is otherwise configured to couple with the winch hook 108 to facilitate coupling the airplane 2 with the winch-capture system 72. In yet other embodiments, the winch-capture system 72 omits the airplane coupler 110 and the winch hook 108 engages directly with the tow element 8 or the pivot 7 to couple the nose gear 4 of the airplane 2 with the winch-capture system 72. In some embodiments, the winch-capture system 72 does not include the winch hook 108 such that the airplane coupler 110 is configured to couple the nose gear 4 of the airplane 2 with the winch-capture system 72. In such embodiments, the airplane coupler 110 may be coupled with (e.g., integrally formed with) the winch strap 106 at the free end thereof.

As shown in FIG. 5, the storage compartment 112 is configured to provide a space (e.g., a pocket, a hook, a compartment, etc.) to store or otherwise secure the winch hook 108 and/or the airplane coupler 110 when not in use. The storage compartment 112 facilitates securing the winch hook 108 and/or the airplane coupler 110 to prevent unintentional movement thereof during driving operations of the tractor 10, for example. In some embodiments, the storage compartment 112 is configured to store or otherwise secure a portion of the winch strap 106 (e.g., a portion of the winch strap 106 extending outside of the body 20 and not wound around the winch drum 104) when not in use.

The cradle assembly 80 is configured to operate with the winch assembly 100 to facilitate coupling the airplane 2 with the tractor 10 using the capture system 70. To capture (e.g., couple and secure) the airplane 2, the tractor 10 is driven to position the cradle 82 in front of the nose gear 4, and the cradle 82 is actuated by the lift actuators 92 to the second, lowered position. In the second, lowered position, the cradle 82 (i) is positioned such that the bottom plate 84 (e.g., or the wear plate) contacts the ground surface and (ii) provides a surface (e.g., a ramp) for the nose gear 4 to contact. The motor 102 of the winch assembly 100 drives the winch drum 104 to payout the winch strap 106 with the winch hook 108 and/or the airplane coupler 110 coupled thereto. The winch drum 104 pays out a sufficient length of the winch strap 106 therefrom such that the winch hook 108 and/or the airplane coupler 110 can reach the nose gear 4 and be coupled therewith (e.g., by a coupling with the tow element 8, by a direct coupling with the pivot 7, etc.). With the airplane 2 coupled with the tractor 10 by the winch-capture system 72, and with the cradle 82 in the second, lowered position, the motor 102 drives the winch drum 104 to retract the winch strap 106. Retraction of the winch strap 106 pulls the cradle 82 in a direction towards the airplane 2. In other words, the airplane 2 remains stationary and the tractor 10 travels forward in a direction towards the airplane 2 as the winch strap 106 is retracted such that the bottom plate 84 of the cradle 82 is pulled underneath the wheels 6 of the nose gear 4. In some embodiments, the prime mover 52 provides power to drive the front tractive assembly 56 and/or the rear tractive assembly 58 as the winch strap 106 is being retracted. The motor 102 may continue to provide rotational energy to the winch drum 104 to retract the winch strap 106 until the nose gear 4 is supported and fully received by the cradle 82 (e.g., when the wheels 6 are positioned over the bottom plate 84, when the wheels 6 contact the switch plate 90, when the winch strap 106 is fully retracted, etc.).

In some embodiments, instead of retracting the winch strap 106 such that the airplane 2 remains stationary and the tractor 10 travels forward in a direction towards the airplane 2, retraction of the winch strap 106 pulls the airplane 2 in a direction towards the cradle 82. In other words, the tractor 10 remains stationary and the airplane 2 travels in a direction towards the tractor 10 as the winch strap 106 is retracted such that the wheels 6 of the nose gear 4 are pulled over the top of the bottom plate 84 of the cradle 82. In such embodiments, prior to retracting the winch strap 106 to pull the airplane 2, the braking system 60 may be engaged to prevent rotation of the tractive elements of the front tractive assembly 56 and/or the rear tractive assembly 58 to prevent movement of the tractor 10.

After the nose gear 4 is received by and loaded onto the cradle 82, the lift actuators 92 may extend to transition the cradle 82 from the second, lowered position to the first, raised position. In the first, raised position, the cradle 82 lifts and spaces the nose gear 4 from the ground surface. With the airplane 2 secured to the tractor 10 by the winch-capture system 72 and the cradle assembly 80 supporting the nose gear 4 off of the ground surface, and when the tractor 10 is driven, the winch-capture system 72 facilities pushing or pulling the airplane 2 with the tractor 10 to tow, push, and otherwise reposition the airplane 2. In this manner, responsive to the tractor 10 being driven, the winch-capture system 72 (e.g., the winch hook 108, the airplane coupler 110, the cradle 82, etc.) exerts a force on the airplane 2 such that the airplane 2 is driven at the same speed, in the same direction, and is maintained at a fixed distance from the tractor 10. In some embodiments, when the tractor 10 turns, the wheels 6 pivot relative to the fuselage of the airplane 2 and exert a force on the airplane 2 to pull the airplane 2 in the direction of the tractor 10. In other embodiments, when the tractor 10 turns, the wheels 6 remain fixed relative to the fuselage of the airplane 2.

To unload the airplane 2 from the tractor 10, the cradle 82 is transitioned (e.g., lowered) from the first, raised position to the second, lowered position. The winch-capture system 72 may disengage such that rotation of the winch drum 104 is not inhibited (e.g., the winch drum 104 is free to rotate and pay out the winch strap 106 therefrom). When the winch-capture system 72 is disengaged, and the cradle 82 is in the second, lowered position, the tractor 10 may drive in a direction away from the airplane 2 (e.g., rearward in a direction toward the rear end 24) such that the nose gear 4 is unloaded from the cradle 82. In other words, the airplane 2 remains stationary and the tractor 10 travels rearward or away from the nose gear 4. In some embodiments, the winch strap 106 is paid out by the motor 102 from the winch drum 104 before the nose gear 4 is unloaded from the cradle 82 or as the nose gear 4 is being unloaded from the cradle 82. The airplane coupler 110 can then be decoupled from the nose gear 4.

### Hands-Free Capture System

In some embodiments, the tractor 10 does not include the winch-capture system 72, but rather the tractor 10 includes the hands-free capture system 200. The hands-free capture system 200 may include a second aircraft support assembly or cradle assembly, a shaft, a plurality of arms, and a plurality of actuators. Such components may be used to engage with and secure the nose landing gear 4 to the tractor 10 without requiring an operator to manually interact with the nose gear 4 of the airplane 2. The plurality of arms may be pivotably coupled to opposing ends of the shaft. The plurality of actuators may be configured to pivot, extend, and retract the plurality of arms relative to the tractor 10 and the shaft. The plurality of arms may be configured to selectively engage with the nose gear 4 to couple the nose gear 4 with the tractor 10 with the airplane 2. By way of example, the plurality of arms and the cradle may include engagement features configured to engage with the rear and/or front of the wheels 6.

### Control System

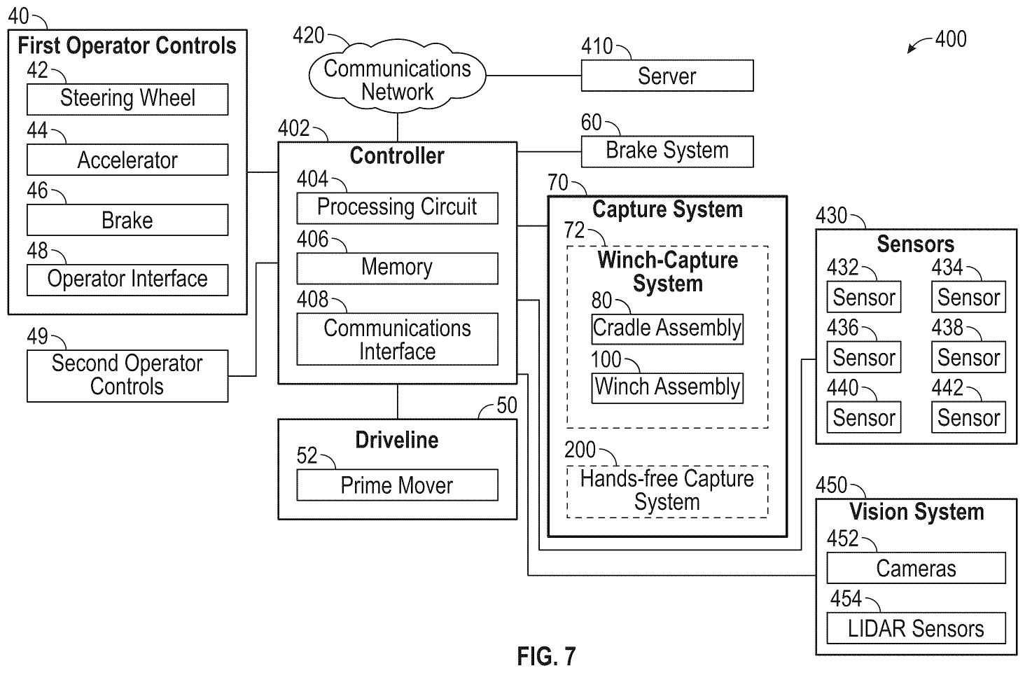

As shown in FIG. 7, the tractor control system 400 includes the first operator controls 40, the second operator controls 49, a controller 402, a remote system, shown as server 410, positioned remote or separate from the tractor 10, one or more first sensors, shown as sensors 430; and a monitoring system, shown as vision system 450. The controller 402 and the server 410 are configured to communicate via one or more communications protocols (e.g., Bluetooth, Wi-Fi, cellular, radio, through the Internet, etc.) through a network, shown as communications network 420.

As shown in FIG. 7, the controller 402 includes a processing circuit 404, a memory 406, and a communications interface 408. The controller 402 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. The processing circuit 404 may include an ASIC, one or more FPGAs, a DSP, circuits containing one or more processing components, circuitry for supporting a microprocessor, a group of processing components, or other suitable electronic processing components. In some embodiments, the processing circuit 404 is configured to execute computer code stored in the memory 406 to facilitate the activities described herein. The memory 406 may be any volatile or non-volatile or non-transitory computer-readable storage medium capable of storing data or computer code relating to the activities described herein. According to an exemplary embodiment, the memory 406 includes computer code modules (e.g., executable code, object code, source code, script code, machine code, etc.) configured for execution by the processing circuit 404. In some embodiments, the controller 402 may represent a collection of processing devices. In such cases, the processing circuit 404 represents the collective processors of the devices, and the memory 406 represents the collective storage devices of the devices.

In one embodiment, the controller 402 is configured to selectively engage, selectively disengage, control, or otherwise communicate with components of the tractor 10 (e.g., via the communications interface 408, a controller area network (“CAN”) bus, etc.). According to an exemplary embodiment, the controller 402 is coupled to (e.g., communicably coupled to) components of the first operator controls 40 (e.g., the steering wheel 42, the accelerator 44, the brake 46, the operator interface 48, etc.), components of the second operator controls 49, components of the driveline 50 (e.g., the prime mover 52), components of the braking system 60, components of the capture system 70 (e.g., the lift actuators 92 of the cradle assembly 80, the motor 102 of the winch assembly 100, the hands-free capture system 200, etc.), the sensors 430, and the vision system 450. By way of example, the controller 402 may send and receive signals (e.g., control signals, location signals, etc.) with the components of the first operator controls 40, the components of the second operator controls 49, the components of the driveline 50, the components of the braking system 60, the components of the capture system 70, the sensors 430, the vision system 450, and/or remote systems or devices (via the communications interface 408) including the server 410. By way of another example, the controller 402 may make determinations and control operation of the one or more components of the tractor 10 responsive to signals received by the sensors 430 and/or the vision system 450 indicative of the data captured thereby.

The sensors 430 may include various sensors positioned about the tractor 10 to acquire tractor information or tractor data regarding operation of the tractor 10 and/or the location thereof. By way of example, the sensors 430 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring tractor information or tractor data regarding operation of the tractor 10 and/or the location thereof. According to an exemplary embodiment, one or more of the sensors 430 are configured to facilitate detecting and obtaining data relating to the airplane 2 and one or more components thereof including a position of the airplane 2 relative to the tractor 10, a position of the wheels 6 relative to the cradle 82 (e.g., an angle of the wheels 6, a lateral/longitudinal position of the wheels 6 relative to the sidewalls 86 and/or the bottom plate 84, etc.), a type of aircraft (e.g., manufacturer, model, size, etc.), and/or other aircraft data. According to another exemplary embodiment, one or more of the sensors 430 are configured to facilitate detecting and obtaining data relating to the operation of the tractor 10 and one or more components thereof including a position of the cradle 82 (e.g., a distance the cradle 82 is from the ground surface, length of extension of the lift actuators 92, whether the cradle 82 is in the first, raised position or the second, lowered position, etc.), whether the winch hook 108 and/or the airplane coupler 110 are stored inside of the storage compartment 112, a speed of the tractor 10, a position of the tractor 10, and/or other tractor data.

As shown in FIGS. 2, 3, and 7, the sensors 430 include a first sensor (e.g., a limit switch, a position sensor, a mechanical switch, etc.), shown as sensor 432, configured to detect whether an operator is sitting on the seat 36. By way of example, the sensor 432 may be coupled with the seat 36 such that when the operator sits in the seat 36, the seat 36 comes into contact or otherwise engages the sensor 432. Responsive to engagement of the sensor 432, a determination may be made by the controller 402 or the server 410 that the operator is sitting in the seat 36. In some embodiments, the sensor 432 is another type of sensor (e.g., vision sensor, camera, etc.) configured to detect the presence or absence of the operator in the forward travel compartment 32 and/or the rearward travel compartment 34. While only shown as being coupled to one of the seats 36, it should be understood that the sensors 432 may be coupled to both seats 36.

As shown in FIGS. 2, 5, and 7, the sensors 430 include one or more second sensors (e.g., a wheel angle sensor, a potentiometer, a string potentiometer, an accelerometer, an inertial measurement unit, etc.), shown as sensors 434, configured to detect a steering angle of the tractive elements of the front tractive assembly 56 and/or the rear tractive assembly 58. As shown in FIGS. 2 and 5, the sensors 434 are positioned at or proximate the left tractive elements of the front tractive assembly 56 and the right tractive elements of the front tractive assembly 56. In some embodiments, the sensors 434 are additionally or alternatively positioned at or proximate the left tractive elements of the rear tractive assembly 58 and the right tractive elements of the rear tractive assembly 58.

As shown in FIGS. 2, 5, and 7, the sensors 430 include a third sensor (e.g., a nose gear sensor, a proximity sensor, a camera, etc.), shown as sensor 436, configured to detect the position of the nose gear 4 relative to the capture system 70. By way of example, the sensor 436 may be coupled to the cradle 82 at a position corresponding to a position where the nose gear 4 is fully loaded onto the cradle 82 if the sensor 436 detects the nose gear 4. In such an example, responsive to a detection of the nose gear 4 (e.g., the wheels 6) by the sensor 436, a determination may be made by the controller 402 that the nose gear 4 is fully loaded onto the cradle 82. By way of another example, the sensor 436 may be coupled to the hands-free capture system 200 to detect a position of the nose gear 4 relative to the cradle to determine whether the nose gear 4 is in a suitable position to be raised from the ground surface by the cradle. In some embodiments, the sensor 436 is otherwise configured and/or positioned to detect a position of the wheels 6 relative to the capture system 70 (e.g., an angle of the wheels 6, a lateral/longitudinal position of the wheels 6 relative to the sidewalls 86 and/or the bottom plate 84, a position of the plurality of arms and the cradle relative to the wheels 6, etc.).

As shown in FIGS. 2, 5, and 7, the sensors 430 include a fourth sensor (e.g., a switch plate sensor, a position sensor, a mechanical switch, etc.), shown as sensor 438, configured to detect a position of the switch plate 90. By way of example, when the nose gear 4 comes into contact with the switch plate 90, the switch plate 90 pivots and comes into contact or otherwise engages with the sensor 438. In such an example, responsive to engagement of the sensor 438, a determination may be made by the controller 402 that the nose gear 4 is fully loaded by the capture system 70 (e.g., onto the cradle 82 and winching operations may be stopped).

As shown in FIGS. 2, 5, and 7, the sensors 430 include a fifth sensor (e.g., a winch sensor, a load sensor, a position sensor, a speed sensor, etc.), shown as sensor 440, configured to monitor operation of the winch-capture system 72. By way of example, the sensor 440 may include a load sensor or strain gauge configured to monitor the tension or strain on the winch strap 106 during loading and unloading operations. By way of another example, the sensor 440 may include a rotary encoder configured to monitor the rotation of the winch drum 104 to determine a length of the winch strap 106 that has been wound or unwound therefrom and/or a rate at which the winch strap 106 is wound or unwound therefrom.

As shown in FIGS. 2, 5, and 7, the sensors 430 include a sixth sensor (e.g., a winch hook sensor, a position sensor, a proximity sensor, etc.), shown as sensor 442, configured to monitor the position of the winch hook 108 and/or the airplane coupler 110. By way of example, the sensor 442 may be configured to facilitate determining whether the winch hook 108 and/or the airplane coupler 110 is secured by the storage compartment 112. By way of another example, the sensor 442 may be configured to facilitate monitoring the position of the winch hook 108 and/or the airplane coupler 110 to determine whether the winch hook 108 and/or the airplane coupler 110 are sufficiently retracted. In some embodiments, a determination is made that (i) the winch hook 108 and the airplane coupler 110 are sufficiently retracted and/or (ii) the winch hook 108 and/or the airplane coupler 110 are secured using the storage compartment 112 when a mechanical, electromechanical, electrical, magnetic, etc. connection is established between the sensor 442 and the winch hook 108 and/or the airplane coupler 110. By way of example, the connection may be established via physical contact or sufficiently close proximity between the sensor 442 and the winch hook 108 and/or the airplane coupler 110. When the connection is made, a determination may be made by the controller 402 that (i) the winch hook 108 and the airplane coupler 110 are sufficiently retracted and/or (ii) the winch hook 108 and/or the airplane coupler 110 are secured using the storage compartment 112. Monitoring whether the winch hook 108 and the airplane coupler 110 are sufficiently retracted and whether the winch hook 108 and/or the airplane coupler 110 are secured using the storage compartment 112 helps prevent unintentional movement thereof during driving operations of the tractor 10 and may facilitate prevention of driving the tractor 10 without first retracting or winding up the winch hook 108 and/or the airplane coupler 110.

The vision system 450 includes one or more first sensors, shown as cameras 452, and one or more second sensors, shown as LIDAR sensors 454. The cameras 452 and the LIDAR sensors 454 may be variously positioned about the tractor 10 to acquire tractor information or tractor data regarding operation of the tractor 10, operation of the airplane 2, and/or a surrounding environment. The cameras 452 are configured to capture image data including videos and/or still images. The LIDAR sensors 454 are configured to capture distance measurements, three-dimensional maps, perform object detection and recognition, and/or capture other LIDAR data. The image data from the cameras 452 and the LIDAR data from the LIDAR sensors 454 may be transmitted to the operator interface 48 and/or the second operator controls 49 to be displayed on the one or more displays thereof. According to an exemplary embodiment, one or more of the cameras 452 and/or LIDAR sensors 454 are configured to facilitate obtaining data relating to the airplane 2 and one or more components thereof including a position of the airplane 2 relative to the tractor 10, a position of the wheels 6 relative to the capture system 70 (e.g., an angle of the wheels 6, a lateral/longitudinal position of the wheels 6 relative to the sidewalls 86 and/or the bottom plate 84, etc.), a height of a fuselage of the airplane 2, a height of the turbines on the airplane 2, a wing height of the airplane 2, and/or other aircraft image data. According to another exemplary embodiment, one or more of the cameras 452 and/or LIDAR sensors 454 are configured to facilitate obtaining data relating to the operation of the tractor 10 and one or more components thereof including a position of components of the capture system 70 and/or other tractor data. In some embodiments, the cameras 452 and/or LIDAR sensors 454 are configured to continuously capture data or periodically capture data (e.g., take a picture every 1 second, 5 seconds, 30 seconds, etc., record a 30 second, 1 minute, 5 minute, etc., long video every 30 seconds, 1 minute, 5 minutes, etc., capture data every 1 second, 5 seconds, 30 seconds, etc.). The cameras 452 and/or LIDAR sensors 454 may be configured to capture data responsive to an event (e.g., a detection that the tractor 10 crashed, a detection that the airplane 2 crashed, a detection of an improper alignment of the airplane 2 with the capture system 70, a detection that the airplane 2 is not present when it should be present, at the completion of capturing the nose gear 4, etc.) and communicate the data captured before the detection of the event (e.g., 30 seconds before, 1 minute before, 5 minutes before, etc.), after the detection of the event (e.g., 30 seconds after, 1 minute after, 5 minutes after, etc.), and/or during the detection of the event. In some embodiments, the data captured by the vision system 450 is used to autonomously drive the tractor 10 (e.g., with or without the airplane 2 coupled therewith), recognize one or more objects (e.g., recognize an operator, recognize a type of the airplane 2, etc.), detect one or more objects or hazards and control one or more components of the tractor 10 to avoid a collision with the hazard or object, assist the operator to perform one or more functions (e.g., assist in aligning the capture system 70 with the airplane 2), and/or for one or more other processes.

The server 410 may include one or more processors that execute one or more software programs to perform various processes (e.g., the method 500). The server 410 may include processors and non-transitory, computer readable medium including instructions, which, when executed by the processors, cause the processors to perform methods disclosed herein. The processor may include any number of physical, hardware processors. Although FIG. 7 shows only a single server 410, the server 410 may include any number of computing devices. The server 410 may perform all or portions of the processes performed by the controller 402. In other words any of the functions or processes described herein with respect to the controller 402 may be performed by the controller 402 and/or the server 410. By way of example, data collection may be performed by the controller 402 and data analytics may be performed by the controller 402. By way of another example, data collection may be performed by the controller 402 and data analytics may be performed by the server 410. By way of yet another example, data collection may be performed by the controller 402, a first portion of data analytics may be performed by the controller 402, and a second portion of data analytics may be performed by the server 410. By way of still another example, a first portion of data collection may be performed by the controller 402, a second portion of data collection may be performed by the server 410, and data analytics may be performed by the controller 402 and/or the server 410.

The server 410 may be configured to facilitate operator access to dashboards including the aircraft data, the tractor data, the image data, information available to the controller 402, etc. to manage and operate the tractor 10 such as to control raising and lowering operations of the cradle assembly 80 and/or winching operations of the winch-capture system 72, controlling operations of the hands-free capture system 200, remotely operating the tractor 10, etc. By way of example, the server 410 may be accessible via a user device (e.g., computer, laptop, smartphone, tablet, smart watch, etc.). The server 410 may also be configured to facilitate operator implementation of configurations and/or parameters for the tractor 10 (e.g., setting speed limits, setting wheel angle limits, etc.). Such configurations and/or parameters may be propagated to the controller 402 of the tractor 10 via the communications network 420 (e.g., as updates to settings) and/or used for real time control of the tractor 10 by the server 410.

### Method for Capturing Airplane

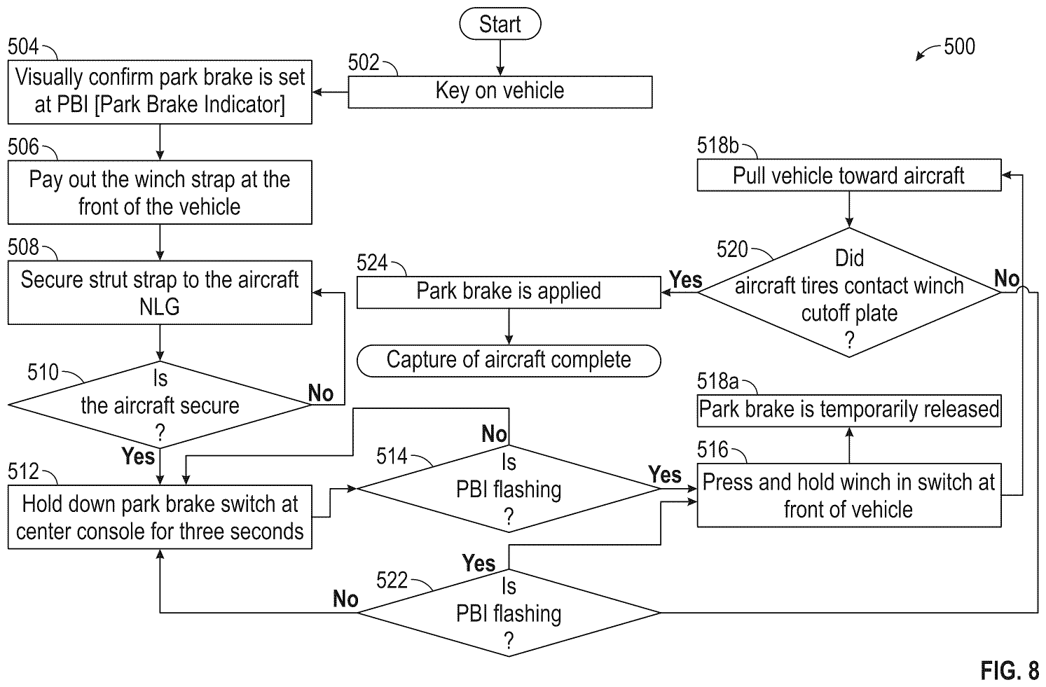

As shown in FIG. 8, a method for capturing an aircraft (e.g., the airplane 2) using a vehicle (e.g., the tractor 10) and without requiring an operator to drive the vehicle to perform the capture process, shown as method 500, includes steps 502-524. The method 500 may be executed, in part, by the tractor control system 400. Further, any computing device described herein can be configured to perform at least a portion of the method 500 (e.g., the processing circuit 404 of the tractor 10, a processing circuit of the server 410, an operator device, etc.).

At step 502, the method 500 begins responsive to receiving a “key on” signal. The “key on” signal may be transmitted from first operator controls (e.g., the first operator controls 40) responsive to an operator powering the vehicle “ON”. By way of example, to power the vehicle “ON”, the operator may insert a key into an ignition (e.g., the operator interface 48) and turn the key, press a button, enter a forward travel compartment (e.g., the forward travel compartment 32) or a rearward travel compartment (e.g., the rearward travel compartment 34), or otherwise interact with the vehicle (e.g., even if no key or button is turned or pressed). In some embodiments, powering the tractor “ON” includes (i) powering the prime mover (e.g., starting the internal combustion engine, providing energy to the electric motor, such that power can be provided to drive tractive elements of the vehicle, etc.) or (ii) powering one or more other systems of the vehicle without powering the prime mover (e.g., an “accessory” position of the ignition, pressing a button without starting the prime mover, powering the first operator controls 40, the braking system 60, capture system 70, the sensors 430, the vision system 450, the second operator controls 49, etc.).

Once the vehicle is keyed “ON”, the vehicle can be driven toward a nose landing gear (“NLG”) (e.g., the nose gear 4) of the aircraft so that a capture process can commence. Once the vehicle is in the proper position to start the capture process, the operator may switch the vehicle into neutral and/or engage a parking brake (e.g., by pressing or engaging a park brake input or switch, via the operator interface 48). At step 504, the operator visually confirms that the park brake is set (e.g., engaged, activated, etc.) by confirming that a park brake indicator is “ON”. The park brake indicator may be or include one or more displays such as a touchscreen, a LCD display, a LED display, a gauge, warning lights, etc., configured to provide an indication (e.g., display a message, audibly play a message/sound, illuminate a light utilizing the operator interface 48, etc.) of whether the park brake is set. When the park brake is set, a braking system (e.g., the braking system 60) is configured to brake the front tractive elements and/or the rear tractive elements of the vehicle to prevent rotation thereof, and the park brake indicator is configured to provide an indication that the park brake is set. In some embodiments, a controller (e.g., the controller 402, the server 410, etc.) is configured to determine whether the park brake is set and transmit a signal to the park brake indicator to provide an indication of whether the park brake is set.

At step 506, a winch-capture system (e.g., the winch-capture system 72) of the vehicle pays out a winch strap (e.g., the winch strap 106) from a winch drum (e.g., the winch drum 104) at a front end (e.g., the front end 22) of the vehicle. By way of example, responsive to a motor (e.g., the motor 102) driving the winch drum in a first direction, the winch strap is unwound (e.g., paid out, let out, etc.) from the winch drum. In some embodiments, the park brake is automatically set when a winch pay-out function is performed (e.g., eliminating step 504). In some embodiments, the winch pay-out function is prevented or prohibited until the park brake is engaged. In some embodiments, the park brake is automatically set when the operator gets out of an occupant seating area (e.g., the occupant seating area 30, not detecting a presence of the operator in the seat 36 via the sensor 432, etc.). In some embodiments, the winch strap is paid out from the winch drum responsive to the operator providing an input to the first operator controls and/or second operator controls (e.g., the second operator controls 49). By way of example, the operator may press a button, pull a lever, turn a knob, etc., to pay the winch strap out from the winch drum. The park brake remains engaged to prevent movement of the vehicle during step 506. At step 508, a strut strap (e.g., the airplane coupler 110, etc.) of the winch strap is coupled (e.g., secured) to the NLG of the aircraft by the operator.

At step 510, a determination is made regarding whether the aircraft is coupled with and secured to the vehicle via the winch and strut straps. In some embodiments, the determination is made based on an inspection performed by the operator. By way of example, the operator may visually and/or mechanically inspect the connection between the NLG and the strut strap. In other embodiments, the determination is made by the controller based on data received from sensors (e.g., the sensors 430) and/or a vision system (e.g., the vision system 450). By way of example, the controller may determine that a strain/load on the winch strap exceeds a threshold strain/load, which is indicative of a coupling between the aircraft and the vehicle. By way of another example, the controller may analyze image data captured by the vision system to determine whether the aircraft is coupled with the vehicle. In response to a determination that the aircraft is coupled with the vehicle (step 510, “YES”), the method 500 proceeds to step 512. In response to a determination that the aircraft is not coupled with the vehicle (step 510, “NO”), the method 500 returns to step 508.

At step 512, the operator holds down the park brake input or switch (e.g., of the operator interface 48, of the operator controls 49, etc.) for a predetermined time to enter the vehicle into a capture mode. By way of example, the park brake input or switch may be or include one or more input devices such as buttons, switches, knobs, levers, dials, etc. In such an example, the operator may provide an input (e.g., press, pull, turn, etc.) to the first operator controls and/or the second operator controls for the predetermined time (e.g., 1 second, 3 seconds, 5 seconds, etc.).

At step 514, a determination is made of whether the park brake indicator is flashing. As discussed in greater detail above, the park brake indicator may be or include one or more displays such as a touchscreen, a LCD display, a LED display, a gauge, warning lights, etc. The park brake indicator may be configured to provide an indication (e.g., display a message, audibly play a message/sound, illuminate a light, flash/pulse a light, etc.) of whether the park brake switch has been held for the predetermined time. If the park brake indicator is providing an indication that the park brake switch was held for the predetermined time (step 514, “YES”), the operator knows that the vehicle has entered or engaged the capture mode and the method 500 proceeds to step 516. In response to a determination that the park brake indicator is not providing an indication that the park brake switch was held for the predetermined time (step 514, “NO”), the method 500 returns to step 512 such that the operator would need to continue holding the park brake switch or re-attempt to engage the capture mode.

At step 516, the operator presses and holds down a “winch in” switch of the second operator controls at the front of the vehicle. By way of example, the “winch in” switch may be or include one or more input devices such as buttons, switches, knobs, levers, dials, etc. In such an example, the operator may provide an input (e.g., press, pull, turn, etc.) to the second operator controls (located proximate the front end 22 of the tractor 10 such that the operator is positioned outside of the tractor 10).

At step 518a, responsive to the operator providing an input to the second operator controls (e.g., to the “winch in” switch) at the front of the vehicle, the braking system releases (e.g., disengages, deactivates, etc.) the park brake such that rotation of the front tractive elements and the rear tractive elements of the vehicle is permitted. At step 518b, responsive to the operator providing the input to the second operator controls (e.g., to the “winch in” switch) at the front of the vehicle, the motor drives the winch drum in a second direction opposite the first direction to retract (e.g., take up) the winch strap. Retraction of the winch strap pulls a cradle (e.g., the cradle 82) and the vehicle in a direction towards the aircraft. In other words, the aircraft remains stationary and the vehicle travels forward in a direction towards the aircraft as the winch strap is retracted. In some embodiments, if the operator stops providing the input to the “winch in” switch (e.g., an absence of the input, stops pressing the button, releases the knob/lever, etc.), the braking system re-engages the park brake to prevent rotation of the front tractive elements and/or the rear tractive elements and/or the winch assembly (e.g., winch assembly 100) stops the winching operation to prevent the vehicle from being pulled in the direction towards the aircraft. In some embodiments, if a sensor (e.g., the sensor 432) detects that the operator is sitting in a seat of the vehicle (e.g., seat 36), the braking system re-engages the park brake to prevent rotation of the front tractive elements and/or the rear tractive elements and/or the winch assembly stops the winching operation to prevent the vehicle from being pulled in the direction towards the aircraft. In such embodiments, the operator may, therefore, be required to (i) continue to provide the input and/or (ii) not sit in the seat (e.g., remain outside of the occupant seating area) to release and keep the parking brake released and/or keep the winch function operational. In some embodiments, after the operator (i) stops providing the input to the “winch in” switch and/or (ii) sits in the seat, the method 500 returns to step 516. In other embodiments, after the operator (i) stops providing the input to the “winch in” switch and/or (ii) sits in the seat, the method 500 returns to step 512. Steps 518a and 518b may be executed simultaneously with each other responsive to the operator providing the input to the second operator controls (e.g., to the “winch in” switch) at step 516.

In embodiments where retraction of the winch strap pulls the airplane in a direction towards the cradle (e.g., the tractor remains stationary and the airplane travels in a direction towards the tractor as the winch strap is retracted) such that the wheels of the nose gear are pulled over the top of the bottom plate of the cradle, step 518a may be skipped such that the braking system remains engaged to prevent rotation of the tractive elements of the front tractive assembly and/or the rear tractive assembly. In such embodiments, at step 518b, responsive to the operator providing the input to the second operator controls (e.g., to the “winch in” switch) at the front of the vehicle, the motor drives the winch drum in a second direction opposite the first direction to retract (e.g., take up) the winch strap to pull the airplane on top of the cradle assembly.

At step 520, a determination is made regarding whether tires (e.g., the wheels 6) of the aircraft contacted (or are contacting) a winch cutoff plate (e.g., the switch plate 90, etc.). The controller may be configured to determine whether the tires of the aircraft contacted (or are contacting) the winch cutoff plate based on signal received from a sensor (e.g., the sensor 438) indicative of an engagement thereof. By way of example, the winch cutoff plate is coupled with the sensor (e.g., a winch cutoff plate sensor, a position sensor, a mechanical switch, etc.) configured to detect a position of the winch cutoff plate. By way of example, when the tires of the aircraft come into contact with the winch cutoff plate, the winch cutoff plate pivots and comes into contact or otherwise engages with the sensor. In response to engagement of the sensor, a determination may be made that the tires of the aircraft and, therefore, the NLG is fully loaded onto the cradle (step 520, “YES”), and the method proceeds to step 524. In response to a determination that the sensor has not been engaged (e.g., indicative that the tires of the aircraft have not contacted or are not contacting the winch cutoff plate) (step 520, “NO”), the method 500 proceeds to step 522. In some embodiments, a determination is made regarding whether the NLG is fully loaded onto the cradle based on data acquired by the vision system 450. By way of example, the cameras 452 and/or the LIDAR sensors 454 may acquire data relating to the airplane 2 and one or more components thereof including a position of the airplane 2 relative to the tractor 10, a position of the wheels 6 relative to the capture system 70 (e.g., an angle of the wheels 6, a lateral/longitudinal position of the wheels 6 relative to the sidewalls 86 and/or the bottom plate 84, etc.), among other aircraft data.

At step 522, a determination is made of whether the park brake indicator is flashing or providing another indication. In response to a determination that the park brake indicator is providing the indication (e.g., indicative of the capture mode remaining active) (step 522, “YES”), the method 500 returns to step 516. In response to a determination that the park brake indicator is not providing the indication (e.g., indicative of the capture mode being deactivated) (step 522, “NO”), the method 500 returns to step 512.

At step 524, the braking system engages the park brake to prevent rotation of the front tractive elements and/or the rear tractive elements. Further, at step 524, the motor of the winch assembly stops driving which drum (e.g., winching operations stop). In some embodiments, based on a signal received from the limit switch indicative of the tires of the aircraft coming into contact with the winch cutoff plate, the controller is configured to (i) transmit a signal to the braking system to engage the park brake and (ii) transmit a signal to the winch-capture system to stop the motor. After completing step 524, the aircraft is coupled with the vehicle and the cradle is under and supporting the nose gear, at which point lift actuators (e.g., lift actuators 92) may extend to transition the cradle from the second, lowered position to the first, raised position. In the first, raised position, the cradle lifts and spaces the NLG from the ground surface. With the aircraft secured to the vehicle and the cradle assembly supporting the NLG off of the ground surface, the capture mode or process is completed. The park brake may then be disengaged using the first operator controls and the vehicle can be subsequently driven. When the vehicle is subsequently driven, the capture system facilities pushing or pulling the aircraft with the vehicle to tow, push, and otherwise reposition the aircraft. Accordingly, the capture process (steps 512-524) can be performed entirely with the operator outside of the occupant seating area of the vehicle and proximate the front end thereof and without requiring the operator to drive the vehicle to capture the NLG.

### Winch Assembly Automatic Retraction and Over Retraction Stop

According to an exemplary embodiment, the tractor control system 400 and/or the winch assembly 100 are configured to (i) automatically retract the winch strap 106 with the winch hook 108 and/or the airplane coupler 110 coupled thereto (e.g., to a fully retracted position) and (ii) prevent over-retraction of the winch strap 106 responsive to one or more conditions relating to the capture system 70 and/or the airplane 2 being satisfied. Monitoring operation of the winch assembly 100 to automatically retract the winch strap 106 helps prevent unintentional movement of the winch hook 108 and/or the airplane coupler 110 during driving operations of the tractor 10 and may facilitate prevention of driving the tractor 10 without first retracting or winding up the winch hook 108 and/or the airplane coupler 110. Monitoring operation of the winch assembly 100 to prevent over-retraction of the winch strap 106 may facilitate prevention of damage to the motor 102, the winch drum 104, the nose gear 4, and any other component of the winch assembly 100, the tractor 10, and the airplane 2.

To capture the airplane 2, the controller 402 is configured to operate with the winch assembly 100 to facilitate coupling the airplane 2 with the tractor 10 using the capture system 70. The motor 102 of the winch assembly 100 drives the winch drum 104 to payout and retract the winch strap 106 with the winch hook 108 and/or the airplane coupler 110 coupled thereto. With the airplane 2 coupled with the tractor 10 by the winch-capture system 72, and with the cradle 82 in the second, lowered position, the motor 102 drives the winch drum 104 to retract the winch strap 106. Retraction of the winch strap 106 pulls the cradle 82 in a direction towards the airplane 2 and underneath the wheels 6 of the nose gear 4. In some embodiments, the tractor 10 remains stationary and the airplane 2 travels in a direction towards the tractor 10 as the winch strap 106 is retracted such that the wheels 6 of the nose gear 4 are pulled over the top of the bottom plate 84 of the cradle 82.

### Automatic Retraction

When the winch strap 106 is paid out from the winch drum 104 and a detection is made by the controller 402 that the winch hook 108 and/or the airplane coupler 110 is not coupled with the nose gear 4, the controller 402 may transmit a signal to the winch assembly 100 to start the motor 102 to drive the winch drum 104 to retract the winch strap 106. By way of example, when the winch strap 106 is paid out when it should not be (e.g., during driving operations without the airplane 2 coupled with the tractor 10), the controller 402 may transmit a signal to the winch assembly 100 to start the motor 102 to drive the winch drum 104 to retract the winch strap 106. In some embodiments, the sensor 440 includes a rotary encoder configured to monitor the rotation of the winch drum 104 (e.g., by counting rotations thereof, by counting gear teeth, etc.) to determine a length of the winch strap 106 that has been wound or unwound therefrom. In such embodiments, responsive to a determination by the controller 402 (e.g., based on the data from the rotary encoder) that the winch strap 106 is paid out when it should not be or that the length of the winch strap 106 paid out from the winch drum 104 is too long, the controller 402 may transmit a signal to the winch assembly 100 to start the motor 102 to drive the winch drum 104 to retract the winch strap 106.

According to an exemplary embodiment, the sensor 440 includes a load sensor or strain gauge configured to monitor the tension or strain on the winch strap 106 indicative of whether the winch hook 108 and/or the airplane coupler 110 is coupled with the nose gear 4. In such embodiments, responsive to a determination by the controller 402 that (i) the winch strap 106 is not retracted, (ii) the winch hook 108 and/or the airplane coupler 110 is not coupled with the nose gear 4 (e.g., based on data from the load sensor, the strain gauge, and/or the vision system 450), and/or (iii) the cradle 82 is in the first, raised position (e.g., based on data from the sensors 430 and/or the vision system 450), the controller 402 may transmit a signal to the winch assembly 100 to start the motor 102 to drive the winch drum 104 to retract the winch strap 106. Therefore, when the airplane 2 and the tractor 10 are not coupled with each other (e.g., the winch hook 108 and/or the airplane coupler 110 is not coupled with the nose gear 4, the nose gear 4 is not loaded onto the cradle 82, etc.) and the cradle 82 is raised, the winch strap 106 is retracted (e.g., to a home position, to a fully retracted position, to a position to prevent unintentional movement of the winch hook 108 and/or the airplane coupler 110 during driving operations of the tractor 10, etc.) such that the winch strap 106 is not loose or unwound while the tractor 10 is being driven.

According to an exemplary embodiment, the position of the winch hook 108 and/or the airplane coupler 110 is monitored to determine whether the winch strap 106 is in the fully retracted position. Responsive to a determination that the winch strap 106 is not fully retracted when it should be, the controller 402 may transmit a signal to the winch assembly 100 to start the motor 102 to drive the winch drum 104 to retract the winch strap 106. By way of example, the sensor 442 may be configured to facilitate determining whether the winch hook 108 and/or the airplane coupler 110 is secured by the storage compartment 112. In such an example, responsive to a determination that the winch hook 108 and/or the airplane coupler 110 is not secured by the storage compartment 112, the controller 402 may transmit a signal to the winch assembly 100 to start the motor 102 to drive the winch drum 104 to retract the winch strap 106. In some embodiments, the controller 402 limits operation of the tractor 10 to a first mode of operation (e.g., limits a travel speed, engages a brake, prevents releasing a brake, etc.) until the winch hook 108 and/or the airplane coupler 110 is secured by the storage compartment 112 (either automatically by the controller 402 or manually by an operator using the first operator controls 40 or the second operator controls 49).

### Over Retraction Stop

When the winch strap 106 is paid out from the winch drum 104 and a detection is made by the controller 402 that the winch hook 108 and/or the airplane coupler 110 is coupled with the nose gear 4, the controller 402 may transmit a signal to the winch assembly 100 to start the motor 102 to drive the winch drum 104 to retract the winch strap 106. After the cradle assembly 80 is pulled under the nose gear 4 (or after the nose gear 4 is pulled on top of the cradle assembly 80), the controller 402 may transmit a signal to the winch assembly 100 to stop the motor 102 from driving the winch drum 104 to stop retracting the winch strap 106 (e.g., based on data from the sensors 430 and/or the vision system 450).

According to an exemplary embodiment, responsive to a detection of the nose gear 4 (e.g., the wheels 6) by the sensor 436, a determination may be made by the controller 402 that the nose gear 4 is fully loaded onto the cradle 82. The controller 402 may, in response to determining that the nose gear 4 is fully loaded onto the cradle 82, transmit a signal to the winch assembly 100 to stop the motor 102 from driving the winch drum 104 (e.g., to stop winching operations), thereby preventing over-retracting the winch strap 106.

According to an exemplary embodiment, responsive to engagement of the sensor 438, a determination may be made by the controller 402 that the nose gear 4 is fully loaded by the capture system 70 (e.g., onto the cradle 82), and the controller 402 may transmit a signal to the winch assembly 100 to stop the motor 102 from driving the winch drum 104 (e.g., to stop winching operations), thereby preventing over-retracting the winch strap 106.

According to an exemplary embodiment, the sensor 442 is configured to monitor the position of the winch strap 106, the winch hook 108, and/or the airplane coupler 110. The sensor 442 may be configured to facilitate monitoring the position of the winch strap 106, the winch hook 108 and/or the airplane coupler 110 to determine whether the winch hook 108 and/or the airplane coupler 110 are sufficiently retracted. In some embodiments, a determination is made by the controller 402 that the winch strap 106 is sufficiently retracted when a mechanical, electromechanical, electrical, magnetic, etc. connection is established between the sensor 442 and an end portion of the winch strap 106, the winch hook 108, and/or the airplane coupler 110. By way of example, the connection may be established via physical contact or sufficiently close proximity between the sensor 442 and the end portion of the winch strap 106, the winch hook 108, and/or the airplane coupler 110. By way of another example, the sensor 442 may be configured to detect a metal tag (e.g., an RFID tag) coupled with the winch strap 106 such that a detection of the metal tag is indicative of the winch strap 106, the winch hook 108, and the airplane coupler 110 being sufficiently retracted. Similarly, the sensor 442 may be configured to detect a metal of the winch hook 108 and/or the airplane coupler 110 (e.g., if the winch hook 108 and/or the airplane coupler 110 is manufactured from or includes a metal portion) such that a detection of the metal is indicative of the winch strap 106, the winch hook 108, and the airplane coupler 110 being sufficiently retracted. When the connection is made, a determination may be made by the controller 402 that the winch strap 106, the winch hook 108, and/or the airplane coupler 110 are sufficiently retracted, and the controller 402 may transmit a signal to the winch assembly 100 to stop the motor 102 from driving the winch drum 104 (e.g., to stop winching operations), thereby preventing over-retracting the winch strap 106.

### Automatic Image Data Capture

According to an exemplary embodiment, the cameras 452 and the LIDAR sensors 454 of the vision system 450 are configured to capture image data and LIDAR data used to control operation of the tractor 10 (e.g., by the controller 402 or the server 410). The image data from the cameras 452 and the LIDAR data from the LIDAR sensors 454 may be transmitted to the first operator controls 40 and/or the second operator controls 49 to be displayed on the one or more displays thereof. The image data from the cameras 452 and the LIDAR data from the LIDAR sensors 454 may be transmitted to the server 410 to be displayed on one or more displays of user devices used to access the server 410. The image data from the cameras 452 and the LIDAR data from the LIDAR sensors 454 may be stored on the tractor 10 by the memory 406 and/or stored remote from the tractor 10 by one or more databases (e.g., a database hosted as or operated as a computing device separate from the server 410, a database hosted by the server 410, etc.). According to an exemplary embodiment, one or more of the cameras 452 and/or LIDAR sensors 454 are configured to facilitate obtaining data relating to (i) the airplane 2 and one or more components thereof and (ii) the operation of the tractor 10 and one or more components thereof including a position of components of the capture system 70 and/or other tractor data. The image data from the cameras 452 and the LIDAR data from the LIDAR sensors 454 may be used to, in the event of an accident, provide evidence or feedback relating to the cause of the accident. By way of example, the data may be used to determine a cause of damage to the nose gear 4, a cause of improper alignment or capture of the nose gear 4, etc.

In some embodiments, the cameras 452 and/or LIDAR sensors 454 are configured to continuously capture data or periodically capture data (e.g., take a picture every 1 second, 5 seconds, 30 seconds, etc., record a 30 second, 1 minute, 5 minute, etc., long video every 30 seconds, 1 minute, 5 minutes, etc., capture data every 1 second, 5 seconds, 30 seconds, etc.). The cameras 452 and/or LIDAR sensors 454 may be configured to capture data responsive to an event and communicate the data captured before the detection of the event (e.g., 30 seconds before, 1 minute before, 5 minutes before, etc.), after the detection of the event (e.g., 30 seconds after, 1 minute after, 5 minutes after, etc.), and/or during the detection of the event. In some embodiments, the cameras 452 and/or LIDAR sensors 454 start capturing data responsive to the operator providing an input to the first operator controls 40 and/or the second operator controls 49.

In some embodiments, the event includes a detection that the tractor 10 crashed and/or a detection that the airplane 2 crashed. By way of example, during transportation of the tractor 10 and the airplane 2 towed thereby, the tractor 10 and/or the airplane 2 may unintentionally contact one or more objects (e.g., other vehicles, buildings, hazards, etc.), or otherwise crash. In other embodiments, the event includes the airplane 2 not being engaged with the capture system 70 when the airplane 2 should be engaged with the capture system 70. By way of example, after completion of capturing the nose gear 4, the airplane 2 should be engaged with the capture system 70. In such an example, the event may include the airplane 2 unintentionally disengaging from the capture system 70 (e.g., due to an improper coupling between the airplane 2 and the capture system 70, due to improper handling/navigation of the tractor 10, etc.). In yet other embodiments, the event includes an improper alignment of the airplane 2 with the capture system 70. By way of example, during a capture procedure, the cradle 82 is configured to receive the wheels 6 between the sidewalls 86. In such an example, the event may include a misalignment between the wheels 6 and the sidewalls 86 (e.g., the wheels 6 coming into contact with the sidewalls 86, one or more of the wheels 6 not being positioned between the sidewalls 86, etc.). In still other embodiments, the event includes a completion of engaging the nose gear with the capture system 70. By way of example, the event may include fully loading the wheels 6 onto the cradle 82, raising the cradle 82 to the lifted position, etc.

In some embodiments, the cameras 452 and/or LIDAR sensors 454 are configured to capture data based on a signal received from the sensor 432 indicative of whether the operator is sitting in the seat 36. By way of example, after capturing the airplane 2 using the capture system 70, responsive to a determination by the controller 402 that the operator is not sitting in the seat 36 (e.g., that the operator is outside of the occupant seating area 30, that the operator stood up, etc.), the cameras 452 and/or LIDAR sensors 454 may start capturing (e.g., communicating) data and may communicate the data captured before the detection of the operator not sitting in the seat 36.

In some embodiments, the cameras 452 and/or LIDAR sensors 454 are configured to capture data responsive to engagement of the sensor 438 indicative of the nose gear 4 being fully loaded by the capture system 70. In such embodiments, responsive to engagement of the sensor 438, the cameras 452 and/or LIDAR sensors 454 start (or continue) capturing and communicating the captured data, and the controller 402 transmits a signal commanding the winch assembly 100 to stop winching operations (e.g., stop retracting the winch strap 106).

In some embodiments, the cameras 452 and/or LIDAR sensors 454 are configured to capture data responsive to the winch system 100 being controlled or commanded to wind up the winch strap 106 (e.g., by the controller 402, by the operator via the first operator controls 48 or the second operator controls 49). In some embodiments, the cameras 452 and/or LIDAR sensors 454 are configured to capture data responsive to the controller 402 determining that the nose gear 4 is not secured by the capture system 70 when it should be (i.e., the nose landing gear 4 has not been intentionally unloaded by the capture system 70).

In some embodiments, the cameras 452 and/or LIDAR sensors 454 are configured to continuously or periodically capture the visual data and the controller 402 is configured to (i) save and store and/or transmit a first length of time worth of video, images, and/or other data (e.g., five minutes) to the server 410 prior to or leading up to an event when the event occurs while the airplane 2 is being towed by the tractor 10 and/or (ii) save and store and/or transmit a second length of time worth of video, images, and/or other data (e.g., five minutes) to the server 410 following the event when the event occurs while the airplane 2 is being towed by the tractor 10. By way of example, the event may include the nose gear 4 not being sensed by the sensor 438, an emergency stop of the tractor 10 being engaged, a collision detected, etc. In some embodiments, the controller 402 is configured to transmit a signal to provide an indication of the event. By way of example, in response to the event, the controller 402 may transmit the visual data to the server 410 to display on an external display. By way of another example, in response to the event, the controller 402 may transmit the visual data to a display of the first operator controls 40 and/or the second operator controls 49 for display thereon. By way of still another example, in response to the event, the controller 402 may cause a light (e.g., warning light) and/or speaker (e.g., horn, siren, etc.) to provide the indication (e.g., to the operator of the tractor 10, to personnel outside of and proximate the tractor 10) of the event.

### Differential Speed Winching Operation

According to an exemplary embodiment, the winch-capture system 72 is configured to adjust the rate at which the winch strap 106 is paid out from the winch drum 104 and the rate at which the winch strap 106 is retracted by the winch drum 104. The motor 102 is configured to provide rotational energy to the winch drum 104 to rotate (e.g., drive) the winch drum 104 in a first direction to pay out the winch strap 106 (e.g., unwind the winch strap 106 from the winch drum 104) and in a second direction opposite the first direction to retract the winch strap 106 (e.g., wind the winch strap 106 around the winch drum 104).

In some embodiments, the winch strap 106 is paid out from the winch drum 104 at a rate greater than a rate at which the winch strap 106 is retracted such that the winch strap 106 is paid out faster than the winch strap 106 is retracted. By way of example, the motor 102 may supply rotational energy to the winch drum 104 at a first output (e.g., a first speed) such that the winch strap 106 is paid out at a first rate (e.g., such that the winch drum 104 rotates in the first direction at the first rate), and supply rotational energy to the winch drum 104 at a second output (e.g., a second speed) such that the winch strap 106 is retracted at a second rate less than the first rate (e.g., such that the winch drum 104 rotates in the second direction at the second rate). In some embodiments, the winch-capture system 72 includes a gear box (e.g., a transmission) configured to facilitate adjusting the output speed and torque for rotating the winch drum 104 (e.g., to transition the motor 102 between providing rotational energy at the first output and the second output). Retracting the winch strap 106 (e.g., when the nose gear 4 is coupled with the winch assembly 100) at a rate slower than a rate at which the winch strap 106 is paid out facilitates more precise control over the tension on the winch strap 106 and the positioning of the nose gear 4 relative to the cradle assembly 80 during winching operations. By way of example, a ratio of the first rate to the second rate may be 2:1 or greater.

In some embodiments, the rate at which the winch strap 106 is paid out and the rate at which the winch strap 106 is retracted is controlled based on load (e.g., tension) on the winch strap 106. By way of example, when a determination is made by the controller 402 that the winch assembly 100 is not coupled with the nose gear 4 and therefore not pulling the tractor 10 (e.g., based on the load on the winch strap 106 monitored by the sensor 440, based on data captured by the vision system 450), the motor 102 may drive the winch drum 104 to retract the winch strap 106 at a rate faster than a rate at which the winch strap 106 is retracted if the winch assembly 100 is coupled with the nose gear 4 and pulling the tractor 10. In such an example, the winch strap 106 is retracted at a rate faster when a relatively lesser load is on the winch strap 106 than a rate at which the winch strap 106 is retracted when a relatively greater load is on the winch strap 106. Further, in such an example, when a determination is made by the controller 402 that the winch assembly 100 is not coupled with the nose gear 4 and therefore not pulling the tractor 10, the motor 102 may drive the winch drum 104 to retract the winch strap 106 at a rate that is substantially the same as a rate at which the winch strap 106 was paid out. In some embodiments, the motor 102 drives the winch drum 104 to retract the winch strap 106 at a rate that is greater than a rate at which the winch strap 106 was paid out when a determination is made by the controller 402 that the winch assembly 100 is not coupled with the nose gear 4.

In some embodiments, the rate at which the winch strap 106 is paid out and the rate at which the winch strap 106 is retracted is controlled based on a position of the cradle 82. By way of example, when a determination is made by the controller 402 that the cradle 82 is in the first, raised position (e.g., based on data captured by the sensors 430 and/or the vision system 450), the motor 102 may drive the winch drum 104 to retract the winch strap 106 at a rate faster than a rate at which the winch strap 106 is retracted if the cradle 82 were in the second, lowered position. In such an example, the cradle 82 being in the first, raised position is indicative of no airplane winching operations taking place, in which case the winch strap 106 should be retracted to prevent unintentional movement of the winch strap 106, the winch hook 108, and/or the airplane coupler 110 during driving operations of the tractor 10. In some embodiments, the rate at which the winch strap 106 is paid out and the rate at which the winch strap 106 is retracted is controlled based on one or more other factors (e.g., based on data captured by the sensors 430 and/or the vision system 450).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the tractor 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A towbarless tractor system comprising:
one or more processing circuits configured to:
monitor a capture system of a towbarless tractor based on visual data acquired by a sensor on the towbarless tractor, the capture system configured to engage with a nose gear; and
store or transmit at least a portion of the visual data acquired by the sensor of the towbarless tractor regarding the capture system in response to an event.

2. The towbarless tractor system of claim 1, wherein the event includes the towbarless tractor crashing, an airplane including the nose gear crashing, or the airplane not being engaged with the capture system when the airplane should be engaged with the capture system.

3. The towbarless tractor system of claim 1, wherein the one or more processing circuits are configured to:
control a winch assembly of the capture system to pay out a winch strap, the winch strap configured to engage with the nose gear; and
control the winch assembly to retract the winch strap when the winch strap is coupled with the nose gear, thereby causing the nose gear to be supported by a cradle of the capture system.

4. The towbarless tractor system of claim 3, wherein retracting the winch strap causes the winch assembly to pull the towbarless tractor towards the nose gear such that the cradle is pulled underneath the nose gear.

5. The towbarless tractor system of claim 3, wherein retracting the winch strap causes the winch assembly to pull the nose gear towards the towbarless tractor such that the nose gear is pulled on top of the cradle.

6. The towbarless tractor system of claim 3, wherein the one or more processing circuits are configured to control the winch assembly to stop retracting the winch strap in response to the event.

7. The towbarless tractor system of claim 3, wherein the event includes an improper alignment of the nose gear with the cradle.

8. The towbarless tractor system of claim 3, wherein the event includes a completion of supporting the nose gear by the cradle.

9. The towbarless tractor system of claim 3, wherein the event includes the one or more processing circuits controlling the winch assembly to retract the winch strap.

10. The towbarless tractor system of claim 1, wherein the one or more processing circuits are configured to store or transmit the visual data regarding a first period of time prior to the event, a second period of time during the event, and a third period of time after the event.

11. The towbarless tractor system of claim 1, wherein the towbarless tractor includes operator controls, and wherein the one or more processing circuits are configured to store or transmit at least the portion of the visual data in response to an input to the operator controls.

12. The towbarless tractor system of claim 1, wherein the one or more processing circuits are configured to transmit the visual data to an external display for display thereon.

13. The towbarless tractor system of claim 1, wherein the one or more processing circuits include at least one of (i) a first processing circuit configured to be located on the towbarless tractor or (ii) a second processing circuit configured to be located remote from the towbarless tractor.

14. A towbarless tractor for towing an airplane having a nose gear, the towbarless tractor comprising:
a chassis;
a plurality of tractive assemblies coupled to the chassis;
a capture system including:
a cradle configured to support the nose gear; and
a winch assembly including a winch strap configured to selectively couple with the nose gear, the winch assembly configured to selectively retract such that the cradle supports the nose gear;
one or more sensors configured to capture visual data regarding the capture system and the nose gear; and
a control system configured to:
control the winch assembly to pay out the winch strap;
control the winch assembly to retract the winch strap when the winch strap is coupled with the nose gear, thereby causing the nose gear to be supported by the cradle; and
store or transmit at least a portion of the visual data captured by the one or more sensors in response to an event.

15. The towbarless tractor of claim 14, wherein the control system is configured to store or transmit at least the portion of the visual data captured by the one or more sensors regarding at least one of a first period of time prior to the event, a second period of time during the event, or a third period of time after the event.

16. The towbarless tractor of claim 14, wherein the control system is configured to control the winch assembly to stop retracting the winch strap in response to the event.

17. The towbarless tractor of claim 14, wherein the event includes an improper alignment of the nose gear with the cradle.

18. The towbarless tractor of claim 14, wherein the event includes a completion of supporting the nose gear by the cradle.

19. The towbarless tractor of claim 14, wherein the event includes the nose gear inadvertently disengaging from the cradle.

20. A towbarless tractor system comprising:
one or more processing circuits configured to:
control a capture system of a towbarless tractor to pay out a winch strap, the winch strap configured to engage with a nose gear of an airplane;
control the capture system to retract the winch strap when the winch strap is coupled with the nose gear to pull the towbarless tractor towards the airplane such that a cradle of the capture system is pulled underneath the nose gear;
monitor the capture system based on visual data acquired by one or more sensors on the towbarless tractor; and
store or transmit at least a portion of the visual data in response to an event, the event including at least one of the towbarless tractor crashing, the airplane crashing, an improper alignment of the nose gear with the capture system, full engagement of the capture system with the nose gear, or the airplane inadvertently disengaging from the capture system.
